(19) United States
(12) Patent Application Publication
(10) Pub. No.: US 2006/0195841 A1
(43) Pub. Date: Aug. 31, 2006

(54) Method and apparatus for scheduling maintenance and repair

(76) Inventor: Richard G. Hall, Hudson, FL (US)

Correspondence Address: LARSON AND LARSON, 11199 69TH STREET NORTH, LARGO, FL, 33773, US

(21) Appl. No.: 11/067,416

(22) Filed: Feb. 25, 2005

(51) Int. Cl. G06F 9/46

(52) U.S. Cl. 718/100

(57) ABSTRACT

A method and apparatus for scheduling the calibration, repair, maintenance or upgrade of one or more instruments is described. The method and apparatus includes a timer function that initiates a scan of a transaction database, looking for any transaction that is about to be due, is due or is past due, and upon finding such, initiates a pop-up message at the monitor of an operator that is associated with that transaction, so that the operator will know that they need to perform the associated activity on the associated instrument. Within the pop-up may be a link to directly access a calibration, repair, maintenance or upgrade procedure and possibly a link to a manual for the instrument.

### FIELD OF THE INVENTION

This invention relates to a method and apparatus for scheduling the maintenance and repair of equipment.

### BACKGROUND OF THE INVENTION

During use of high-tech laboratory equipment or the like, periodic calibration, maintenance, upgrades and repair are often required. For example, many multimeters, oscilloscopes, waveform generators, voltage references and power supplies periodically require calibration to assure they are providing accurate outputs and measurements. In some laboratories, internal procedures are established to schedule such calibration several times within each year. Additionally, any equipment used in the manufacture or design of products under the ISO9000 certification are required to be calibrated under strict schedules and failing to do so may jeopardize re-certification with the ISO certification bodies.

Furthermore, when numbers of such equipment rise and are spread around a company, perhaps in many different laboratories or are portable and may be transported among various laboratories, scheduling such calibration, maintenance, upgrades and repair becomes a very difficult task.

What is needed is a computer-based system that will allow for scheduling of the calibration, maintenance, upgrade and repair of each piece of equipment within a company, providing for assigning an operator to perform the activity and for tracking the completion of the activity in order to allow predictions of future activities. Furthermore, a way to track equipment is needed, whereby the cost of maintenance, availability and cost of supplies is tracked and can be reported over a specified period of time is needed.

### SUMMARY OF THE INVENTION

For the purposes of this application, and as seen in FIGS. 1-5, transactions will refer to one or more records stored in a transaction file, database or the like, containing information regarding an activity. The activity may be, for example, a calibration, maintenance, upgrade or repair event. An operator is a person (or perhaps a robot) who will perform the activity.

In one embodiment, a system for scheduling an activity using a computer system is disclosed, in which a transaction file containing records, each record describing an activity is operated upon by a software module running on the computer system. The software module is configured to periodically scan the transaction file for an activity that is due to be performed, is about to be due to be performed or is past due to be performed and upon finding a transaction of this sort, the software module initiates a pop-up message on a monitor associated with the activity.

In another embodiment, a computer-implemented method for scheduling an activity is disclosed, including periodically scanning a set of transactions for an activity that is due or is about to be due or is past due and for each transaction that is about to be due, due or over due initiating a pop-up message at a monitor associated with that transaction. The pop-up message includes an indication, perhaps color coded, as to whether the transaction is about to be due, is due or is over due as well as a link to an on-line procedure associated with the transaction.

In another embodiment, a means for scheduling an activity is disclosed. Included is a means for creating and maintaining a set of transactions, then periodically scanning said set of transactions for transactions that are about to be due, are due, or are over due, then for transactions that are about to be due, are due or are over due: displaying a pop-up message. Also included is a means for updating the transaction after an activity associated with said transaction is completed.

In yet another embodiment, a computer-implemented method for scheduling an activity is disclosed, including providing a set of transactions, each transaction including at least an instrument identifier, an operator identifier, an activity, an activity due date, an activity complete date and a link to a procedure, then periodically scanning the set of transactions for an active transaction that has an empty activity complete date and an activity due date that is due or is about to be due or is past due, then for each active transaction, initiating a pop-up message at a monitor associated with the operator listed on that transaction. The pop-up message indicates that said active transaction is about to be due, is due or is over due, possibly color coded, and also includes a link to the procedure.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a chart of the logical structure of a data structure of the present invention.

FIG. 2 illustrates a process flow diagram of the present invention.

FIG. 3 illustrates a sample transaction file of the present invention.

FIG. 4 is a schematic diagram of a timekeeper system according to the present invention.

FIG. 5 is a schematic diagram of a sample computer system according to the present invention.

### DETAILED DESCRIPTION OF THE INVENTION

Reference will now be made in detail to the presently preferred embodiments of the invention, examples of which are illustrated in the accompanying drawings.

Throughout the following detailed description, the same reference numerals refer to the same elements in all figures.

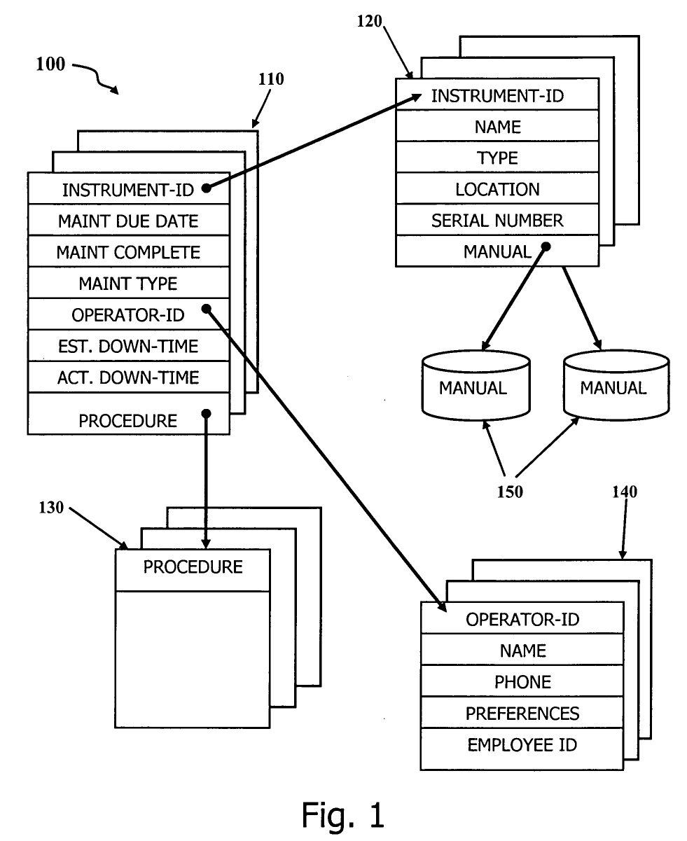

Referring to FIG. 1, a sample data structure or database 100 according to the present invention is shown. In this, there are task records 110 comprising an instrument-id to identify the instrument that is being scheduled, a maintenance due date, indicating when the activity should be performed, a maintenance complete date (to be filled in when the activity is complete), an operator-id (identifying who should perform the activity), an estimated down time and an actual down time (also filled in when the activity is complete). Linked to the task records 110 are instrument records 120 consisting of an instrument-id (linked to task records 110), a name (e.g., xyz-oscilloscope), a type (e.g., digital oscilloscope), a location (e.g., test lab), a serial number and a link to an on-line user manual. The instrument records may also include a link to a user manual 150 for the associated instrument. Also linked to the task records 110 are operator records 140 consisting of an operator-id (linked to task records 110), a name (e.g., Jane Smith), a phone number, a set of preferences (e.g., color preferences) and an employee ID. Also linked to the task records 110 are a set of procedures 130, which can be used by the operator to complete the required activity.

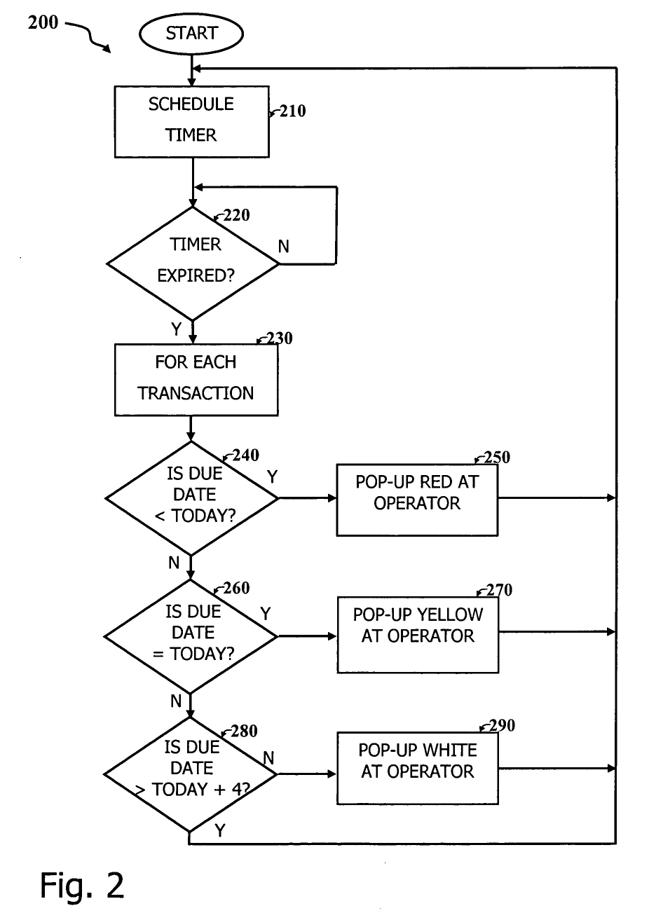

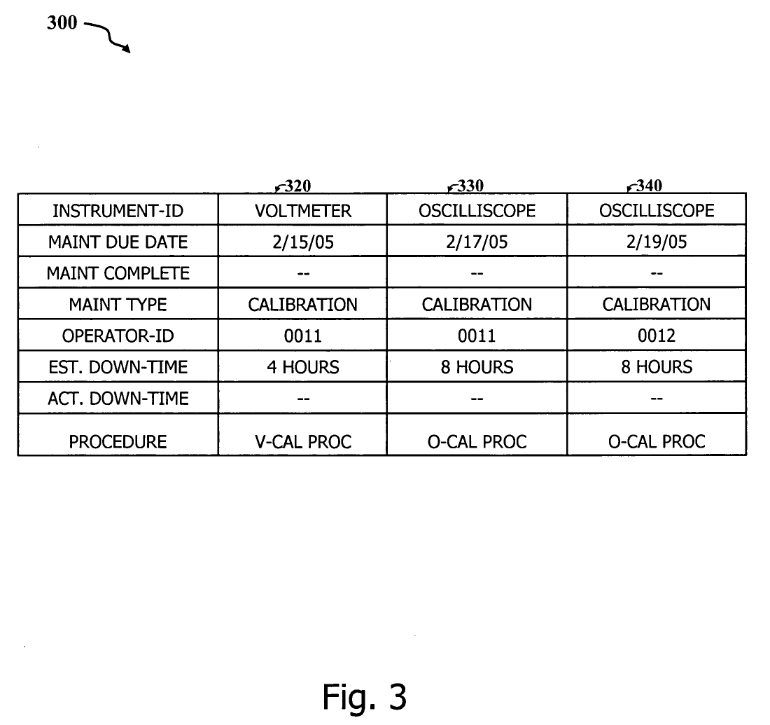

FIG. 2 shows a flow diagram 200 showing an embodiment of the timekeeper in operation. To understand how the timekeeper operates, FIG. 3 will be used as a sample set of task records 300. The timekeeper starts by scheduling a timer 210, then waiting for the timer to expire 220. Once the timer expires, each transaction in the set of task records 300 is checked to see if any are due 230. For this example, let us assume that the current date is Feb. 17, 2005. As the first record 320 is examined, its due date is less than today 240, so a pop-up message is displayed in red at operator 0011's monitor 250. As the second record 330 is examined, its due date is not less than today 240, but its due date is equal to today 260, so a pop-up message is displayed in yellow at operator 0011's computer 270. As the third record 340 is examined, its due date is not less than today 240 and its due date is not equal to today 260 but its due date is not greater than four days from today 280, so a pop-up message is displayed in white at operator 0012's computer 290. In this, a due date of Feb. 16, 2005, Feb. 17, 2005, Feb. 18, 2005 and Feb. 19, 2005 would all not be greater than four days from today, and therefore would pop-up white 290. If the records date was greater than four days from today, for example Feb. 20, 2005, no pop-up message would be displayed. Of course, any number of days could be used to determine when a transaction is soon to be due and there can be more than three tests, perhaps giving advanced notice at ten days, then again at four days.

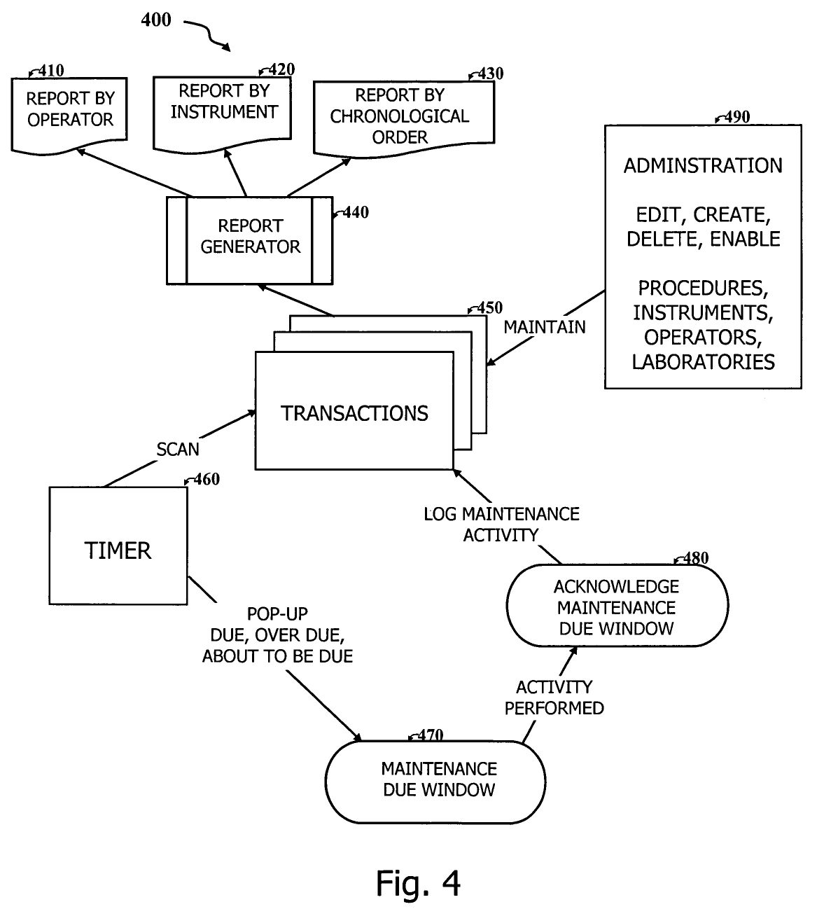

Referring to FIG. 4, a schematic block diagram of a timekeeper system 400 of the present invention is shown. Central to the timekeeper system is the transactions file or database 450. This file or database contains a record for each pending activity as well as completed activity for historical purposes. The administrative function 490 maintains the transactions 450, adding new records, deleting records, editing records, adding new procedures, manuals, operators and instruments, for example. The administrative function 490 may be used to add transaction records for unscheduled functions to track, for example, yearly maintenance costs, yearly disposables costs and yearly down-time. The report generator 440 can scan the transactions 450 and output various reports when needed, for example, reports by operator 410, reports by instrument 420 and reports by chronological order 430. The timer 460 periodically scans the transactions 450 looking for transactions that are due, about to be due or overdue and upon finding one or more, initiates one or more maintenance windows 470 at an operator's monitor to inform the operator that a transaction is due or almost due. Once the activity is complete, the operator acknowledges such, possibly entering details such as elapsed time and parts needed at their monitor 480 and the transaction is updated.

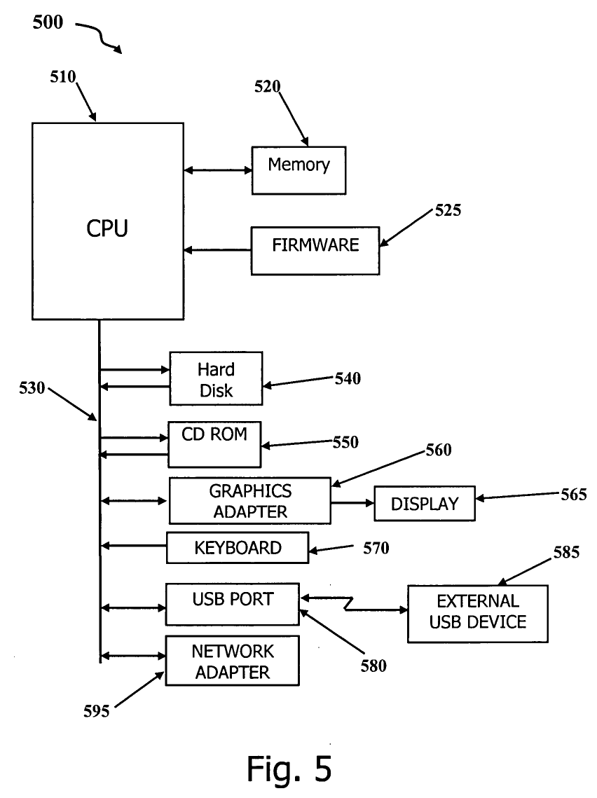

Referring to FIG. 5, a schematic block diagram of a computer-based system 500 of the present invention is shown. In this, a processor 510 is provided to execute stored programs that are generally stored within a memory 520. The processor 510 can be any processor, perhaps an Intel Pentium-5 ® CPU or the like. The memory 520 is connected to the processor and can be any memory suitable for connection with the selected processor 510, such as SRAM, DRAM, SDRAM, RDRAM, DDR, DDR-2, etc. The firmware 525 is possibly a read-only memory that is connected to the processor 510 and may contain initialization software, sometimes known as BIOS. This initialization software usually operates when power is applied to the system or when the system is reset. Sometimes, the software is read and executed directly from the firmware 525. Alternately, the initialization software may be copied into the memory 520 and executed from the memory 520 to improve performance.

Also connected to the processor 510 is a system bus 530 for connecting to peripheral subsystems such as a hard disk 540, a CDROM 550, a graphics adapter 560, a Universal Serial Bus (USB) port 580, a keyboard 570 and a network adapter 595. The graphics adapter 560 receives commands and display information from the system bus 530 and generates a display image that is displayed on the display 565.

In general, the hard disk 540 may be used to store programs, executable code and data persistently, while the CDROM 540 may be used to load said programs, executable code and data from removable media onto the hard disk 540. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Other devices may be connected to the system through the system bus 530 or with other input-output functions. Examples of these devices include printers; mice; graphics tablets; joysticks; and communications adapters such as modems and Ethernet adapters.

In some embodiments, the USB port 580 may be connected to an external USB device 585. The example shown has an external USB device 585 which may be a flash drive, memory card, external hard drive, keyboard or mouse, for example.

Equivalent elements can be substituted for the ones set forth above such that they perform in the same manner in the same way for achieving the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

Having thus described the invention, what is claimed and desired to be secured by Letters Patent is:

1. A system scheduling an activity comprising:
a computer system;
a transaction file containing records, each of said records describing an activity; and
a software module running on said computer system and configured to periodically scan said transaction file for an activity that is due to be performed or an activity that is about to be due to be performed or an activity that is over due to be performed;
wherein said software module initiates a pop-up message on a monitor associated with said activity if said activity is due, is about to be due or is over due.

2. The system of claim 1, wherein said activity is selected from a group consisting of calibration, maintenance, upgrade and repair.

3. The system of claim 1, wherein said records contain at least an instrument-id, an operator-id and a due-date.

4. The system of claim 3, wherein said records also contain a link to a procedure.

5. The system of claim 4, wherein said pop-up message includes an active link to said procedure.

6. The system of claim 5, wherein said pop-up message is color coded with a unique color for each of said activity that is due, said activity that is about to be due and said activity that is over due.

7. The system of claim 1, further comprising a report generator application configured to scan said records and configured to generate reports on past activities and configured to generate reports on future activities.

8. A computer-implemented method for scheduling an activity comprising:
periodically scanning a set of transactions for an activity that is due or is about to be due or is past due; and
for each transaction that is about to be due, due or over due:
initiating a pop-up message at a monitor associated with said each transaction, said pop-up message indicating that said each transaction is about to be due, is due or is over due; and
providing a link within said pop-up message to an on-line procedure associated with said each transaction.

9. The method of claim 8, further comprising a step of accepting an acknowledgement indicating that said activity is complete and marking said transaction as complete.

10. The method of claim 8, wherein said pop-up message is color coded, a first color if said transaction is about to be due, a second color if said transaction is due and a third color if said transaction is over due.

11. The method of claim 10, wherein said first color is white and said second color is yellow and said third color is red.

12. The method of claim 8, wherein said activity is selected from a group consisting of calibration, maintenance, upgrade and repair.

13. The method of claim 8, wherein said link is provided within said pop-up message.

14. A means for scheduling an activity comprising:
means for creating and maintaining a set of transactions;
means for periodically scanning said set of transactions for individual transactions that are about to be due, are due, or are over due;
means for initiating a pop-up message on a monitor associated with said individual transactions that are about to be due, are due or are over due; and
means for updating said individual transaction after an activity associated with said individual transaction has been completed.

15. The means of claim 14, wherein said activity is selected from a group consisting of calibration, maintenance, upgrade and repair.

16. The means of claim 14, further comprising a means to generate reports from said set of transactions.

17. A computer-implemented method for scheduling an activity comprising:
providing a set of transactions, each individual transaction within said set of transactions including at least an instrument identifier, an operator identifier, an activity, an activity due date, an activity complete date and a link to a procedure;
periodically scanning said set of transactions for one or more active transactions that has an empty activity complete date and an activity due date that is due or is about to be due or is past due; and
for each of said active transactions:
initiating a pop-up message at a monitor associated with said operator identifier, said pop-up message indicating that said active transaction is about to be due, is due or is over due, said pop-up message also including a displayed link to said procedure.

18. The method of claim 17, wherein said activity is selected from a group consisting of calibration, maintenance, upgrade and repair.

19. The method of claim 17, further comprising generating reports from said set of transactions.

20. The method of claim 17, wherein said activity is about to be due if said activity due date is less than four days from the current date.
